(19) United States
(12) Patent Application Publication
(10) Pub. No.: US 2005/0273951 A1
(43) Pub. Date: Dec. 15, 2005

(54) Replaceable bristles for electric toothbrush

(76) Inventor: A. Robert Karl, West Linn, OR (US)

Correspondence Address: SMITH-HILL AND BEDELL, P.C., 16100 NW CORNELL ROAD, SUITE 220, BEAVERTON, OR, 97006, US

(21) Appl. No.: 10/865,182

(22) Filed: Jun. 9, 2004

(51) Int. Cl. A61C 17/22

(52) U.S. Cl. 15/22.1; 15/176.1; 15/176.2

(57) ABSTRACT

A conventional electric toothbrush of the type having a vibrating brush head mounted on a battery operated hand unit is modified so that its bristles can be replaced without replacing the entire bristle head. The bristle head includes a first shaft having a proximal end and a distal end, bristles mounted on the distal end of the first shaft, and means for releasably mounting the first shaft on the hand unit and for responding to a force produced by the hand unit by vibrating the first shaft. The bristle head is modified by cutting or otherwise dividing the first shaft to remove the distal end holding the bristles, and then releasably coupling a replacement brush (26) to the new distal end of the first shaft, the replacement brush including a second shaft having a distal end and a proximal end and bristles mounted on the distal end, the proximal end of the second shaft being releasably coupled to the new distal end of the first shaft.

### BACKGROUND OF THE INVENTION

1. Field of the Invention

The invention relates in general to electric toothbrushes and in particular to a modification to an electric toothbrush allowing a user to replace its bristles.

2. Description of Related Art

As illustrated in FIG. 1, a typical electric toothbrush 10 includes a bristle head 12 coupled to a hand unit 14. Bristle head 12 includes a chassis 16 that screws onto hand unit 14, a rigid shaft 18 extending through chassis 12, a set of bristles 20 formed on a distal end of shaft 18, and a magnet 22 attached to a proximal end of shaft 18. Hand unit 14 includes an internal battery and a battery-powered circuit for transmitting an alternating current through a coil 24 mounted under magnet 22. The alternating current produces an alternating magnetic flux around coil 24 producing forces that cause magnet 22 to vibrate, for example, at a frequency of 30 KHz. The rigid shaft 18 transmits the vibrations to bristles 20. Bristles 20 mainly clean teeth by scrubbing them, but their high frequency vibrations also agitate fluid surrounding a user's teeth to produce pressure and shear forces that can dislodge plaque from areas of the teeth bristles cannot reach.

When bristles 20 are worn, a user can remove bristle head 12 from hand unit 14 and replace it with a new bristle head. Multiple users can share the same hand unit while using different bristle heads. However since bristle heads can be expensive, what is needed is a convenient and inexpensive system for replacing the bristles of an electric toothbrush without replacing the entire bristle head.

### SUMMARY OF THE INVENTION

A conventional electric toothbrush of the type having a vibrating brush head mounted on a battery operated hand unit is modified so that its bristles can be replaced without replacing the entire bristle head. The bristle head includes a rigid shaft, bristles mounted on a distal end of the shaft, and means for releasably mounting the shaft on the hand unit and for responding to forces produced by the hand unit by vibrating the first shaft. In accordance with the invention, the bristle head is modified by cutting the first shaft to remove the bristles from the bristle head. A replacement brush is then releasably coupled to the newly exposed end of the first shaft, suitably through a rigid connector having a releasable coupling enabling a user to easily remove the replacement brush. Thereafter a user may easily replace the replacement brush with another one.

The claims appended to this specification particularly point out and distinctly claim the subject matter of the invention. However those skilled in the art will best understand both the organization and method of operation of what the applicant(s) consider to be the best mode(s) of practicing the invention by reading the remaining portions of the specification in view of the accompanying drawing(s) wherein like reference characters refer to like elements.

### BRIEF DESCRIPTION OF THE DRAWINGS

FIG. 1 is a side elevation view of a prior art electric toothbrush with a partial cut away view showing the interior of the conventional electric toothbrush's bristle head.

FIG. 2 is a side elevation view of the bristle head of FIG. 1, removed from the hand unit of FIG. 1, with its shaft cut in accordance with the invention to remove a distal portion of the shaft and the bristles from a lower portion of the bristle head.

FIG. 3 is a sectional side elevation view of the lower portion of the bristle head of FIG. 2, a replacement brush, and a connector for attaching the replacement brush to the lower portion of the bristle head.

FIG. 4 is a side elevation view of the replacement brush, the connector and the lower portion of a bristle head modified in accordance with the invention and ready to be installed on the hand unit of FIG. 1.

FIGS. 5-7 are sectional side elevations views of alternative embodiments of the connector of FIGS. 3 and 4 showing various approaches for connecting the replacement brush to the lower portion of the bristle head.

FIGS. 8-10 depict stages of a method in accordance with an alternative embodiment of the invention for mating a replacement brush to a lower portion of a bristle head.

FIGS. 11-15 are sectional side elevations views of alternative embodiments of a connector for connecting a replacement brush to a lower portion of the bristle head.

### DETAILED DESCRIPTION OF THE INVENTION

The present invention relates in general to electric toothbrushes and in particular to a modification to an electric toothbrush that allows a user to replace its bristles. While the specification describes at least one exemplary embodiment of the invention considered a best mode of practicing the invention, those of skill in the art will appreciate that other modes of practicing the invention are possible.

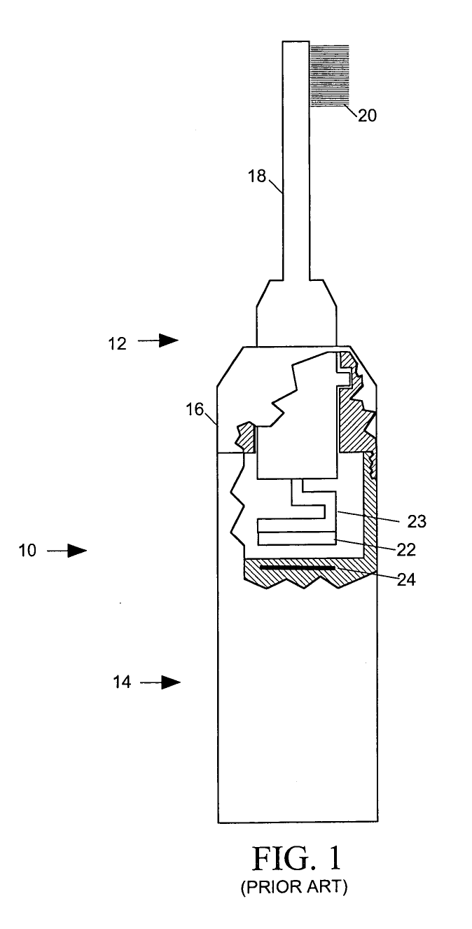

As illustrated in FIG. 1, a typical electric toothbrush 10 includes a bristle head 12 and a hand unit 14. Bristle head 12 includes a chassis 16, a shaft 18 extending through chassis 12, bristles 20 formed on a distal end of shaft 18, and a magnet 22 attached to a proximal end 23 of shaft 18. Hand unit 14 includes an internal battery and a battery-powered circuit for transmitting an alternating current through a coil 24 mounted under magnet 22. The alternating current causes coil 24 to subject magnet 22 to a magnetic flux alternating in polarity, causing magnet 22 to vibrate at a frequency of, for example, 30 KHz. Shaft 18 is free to move vertically within chassis 16 as it transmits the vibrations to bristles 20. Bristles 20 mainly clean teeth by scrubbing them, but their high frequency vibrations also agitate fluids surrounding a user's teeth to produce pressure and shear forces that can dislodge plaque from areas of the teeth bristles cannot reach.

When bristles 20 are worn, a user can unscrew bristle head 12 from hand unit 14 and replace it with a new one, but bristle heads can be expensive. The invention relates to methods for modifying the bristle head of a conventional toothbrush so that only the relatively inexpensive distal portion of the brush head holding bristles 20, rather than the entire bristle head 12, need be replaced.

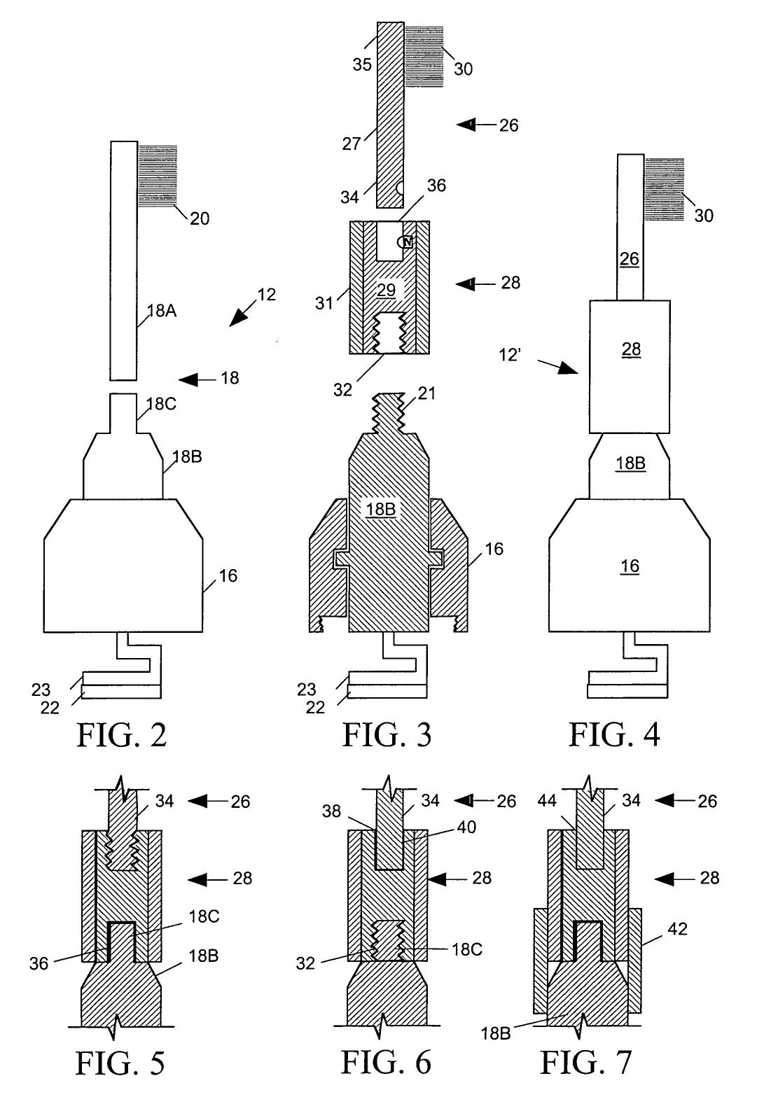

Referring to FIG. 2, using a method in accordance with the invention, a fabricator first cuts shaft 18 of bristle head 12 of FIG. 1 to separate an upper end 18A of the shaft holding bristles 20 from the lower portion 18B of the shaft having a stub 18C at its distal end and magnet 22 mounted on its proximal end 23. As illustrated in FIGS. 3 and 4, the fabricator then couples an inexpensive replacement brush 26 to a stub 18C of the lower portion 18B of shaft 18 though a connector 28. To do so, the fabricator first threads the newly exposed stub end 21 of shaft portion 18B using a conventional threading tool and screws stub 21 into a threaded bore 32 in the lower end of connector 28. Replacement brush 26 includes a shaft 27 having a proximal end 34 and a distal end 35, and a set of bristles 30 mounted on distal end 35. The fabricator then attaches brush 26 to connector 28 through a bayonet fitting, the proximal end 34 of brush 26 providing the male portion of the bayonet fitting, and the upper end of connector 28 forming the female portion 36 of the bayonet fitting. The bayonet fitting (34, 36) provides a releasable coupling between replacement brush 26 and connector 28 so that a user can thereafter easily remove replacement brush 26 from connector 28 and attach another replacement brush to it.

Connector 28 suitably comprises an inner core 29 made of a rigid material, such as rigid plastic or aluminum and an outer shell 31 surrounding inner core 29 and made of a softer material, such as rubber or plastic, for protecting tooth surfaces. The rigidity of inner core 29 enables it to efficiently transmit vibrations to shaft 27 and bristles 30.

While FIG. 3 depicts connector 28 as connecting to stub 21 through a screw fitting and as connecting to brush 26 through a bayonet fitting, those of skill in the art will appreciate that connector 28 can use other types of fittings for such connections. For example, FIG. 5 shows an example implementation of connector 28, wherein glue 36 holds a non-threaded stub 18C within a recess in the lower end of connector 28, and wherein the proximal end of replacement brush 26 of FIG. 3 is threaded and screwed into a threaded recess on the upper end of connector 28. For this version of connector 28, a user removes replacement brush 26 by unscrewing it from connector 28.

FIG. 6 shows another example implementation of connector 28 where glue 40 permanently holds the proximal end 34 of replacement brush 26 in a recess 38 in the upper end of connector 28 while stub 21 is threaded and screwed into a threaded recess 32 in the lower end of connector 28. Since here it is the lower connection that is releasable, a user replaces both connector 28 and the replacement brush 26 when bristles 30 are worn by unscrewing connector 28 from stub 18C. Alternatively, when glue 40 is a thermal-releasing adhesive, the user can remove replacement brush 26 from connector 28 by heating connector 28 to allow the thermal-releasing adhesive to release proximal end 34.

FIG. 7 depicts an example implementation of connector 28 wherein it includes a shrink-wrap sleeve 42 for grasping shaft portion 18B. After inserting a lower end of connector 28 and an upper end of shaft portion 18B within sleeve 42, the fabricator heats sleeve 42, thereby shrinking it so that it tightly grasps shaft portion 18B. In this version of connector 28, the proximal end 34 of replacement brush 26 and a recess 44 in the upper end of connecter 28 form a friction fitting wherein proximal end 34 is held in recess 44 by friction alone. A user can remove replacement brush 26 simply by pulling it out of recess 44.

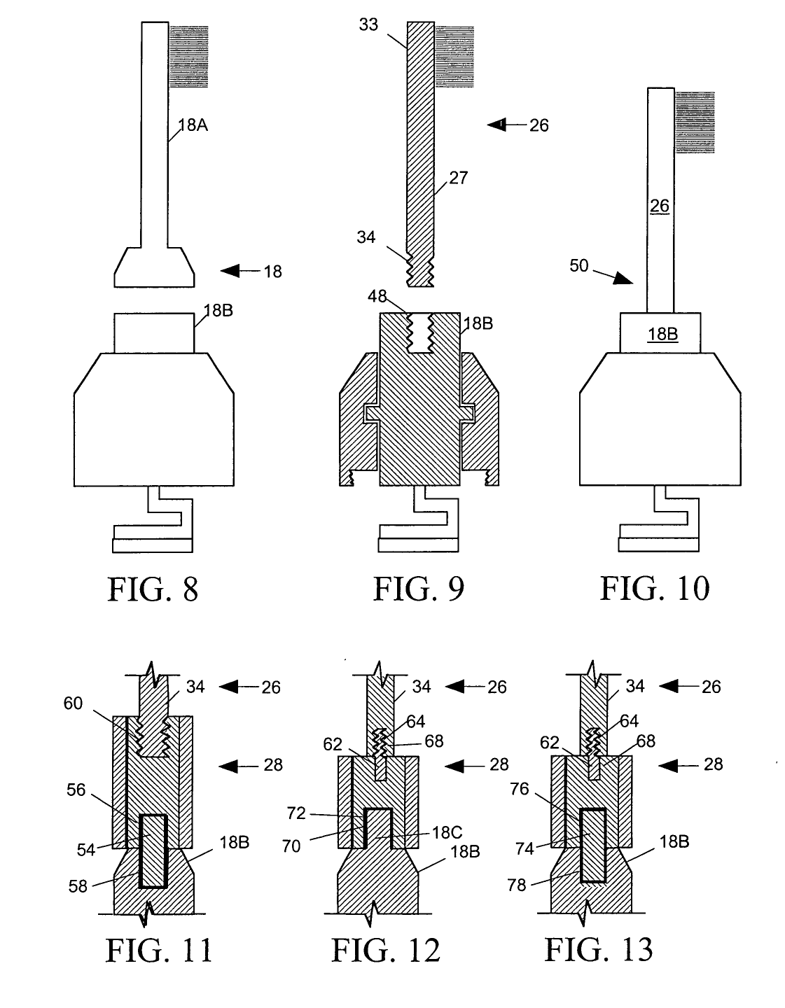

FIGS. 8-10 depict stages of a method in accordance with an alternative embodiment of the invention for mating a replacement brush 26 to a shaft stub 18B when the proximal end of shaft 18 of a bristle head is cut where it is relatively thick, as illustrated in FIG. 8. Replacement brush 26 includes a shaft 27 having a distal end 33 and a threaded proximal end 34, with bristles mounted on distal end 33. After disposing of the upper portion 18A of the shaft, the remaining shaft stub 18B is drilled and tapped to form a threaded recess 48 as shown in FIG. 9. The threaded proximal end 34 of replacement brush 26 is then screwed into threaded recess 48. FIG. 10 shows the resulting assembled brush head 50 in accordance with the invention. Alternatively, a friction, bayonet, thermal-releasing adhesive or other type of releasable coupling could be provided to join the proximal end 34 of replacement brush 26 to shaft stub 18B.

FIG. 11 shows an example implementation of connector 28 for attaching replacement brush 26 to stub 18B, including a pin 54, for example of steel, extending upward into a recess 56 in connector 28 and downward into a recess 58 drilled into stub 18B, pin 54 suitably being glued into place within recess 56 and 58. For this version of connector 28, the proximal end 34 of replacement brush 26 is threaded and then screwed into a threaded recess 60 in the top of connector 28. A user removes replacement brush 26 by unscrewing it from connector 28.

FIG. 12 shows example implementation of connector 28, wherein connector 28 includes a pin 62, for example of steel, at its distal end. Pin 62 has a threaded end 64 screwed into a threaded recess 68 in the proximal end 34 of replacement brush 26. Glue 70 holds a non-threaded stub 18C within a recess 72 in the lower end of connector 28.

FIG. 13 shows example implementation of connector 28 in accordance with the invention, wherein connector 28 includes a pin 62, for example of steel, at its distal end. Pin 62 includes a threaded end 64 screwed into a threaded recess 68 in the proximal end 34 of replacement brush 26. Another pin 74, for example of steel, extending upward into a recess 76 in connector 28 and downward into a recess 78 drilled into stub 18B, pin 74 suitably being glued into place within recess 76 and 78.

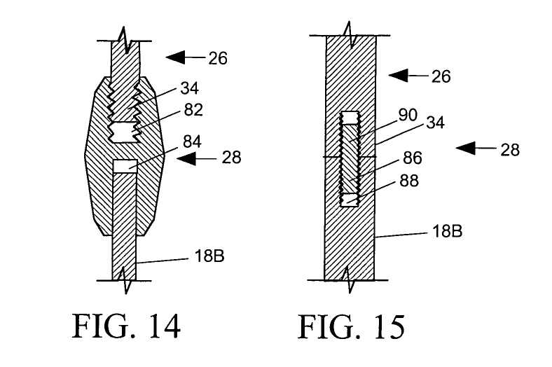

FIG. 14 shows example implementation of connector 28 in accordance with the invention including a distal end having a threaded recess 82 for receiving a threaded proximal end 34 of replacement brush 26 and including a proximal end having a recess 84 for receiving the shaft stub 18B, suitably glued into place.

FIG. 15 shows an example implementation of a connector 28 in accordance with the invention consisting only of a threaded pin 86 engaging a threaded recess 88 formed in shaft stub 18B and engaging a threaded recess 90 formed in the proximal end 34 of replacement brush 26.

While examples of the invention recited in the appended claims are described herein above and shown in the drawings, the scope of the invention is defined by appended claims and not by the examples described herein. Those of skill in the art will appreciate that the invention in the claims can be implemented in other ways. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A bristle head for mounting on a hand unit to form an electric toothbrush, wherein the hand unit includes means for producing a force on the bristle head causing it to vibrate, the bristle head comprising:
a first shaft (18B) having a proximal end (23) and a distal end (21);
a second shaft (27) having a proximal end (34) and a distal end (35);
bristles (30) mounted on the distal end of the second shaft; and
means (16, 22) for releasably mounting the first shaft on the hand unit and for responding to the force produced by the hand unit by vibrating the first shaft, wherein the second shaft and the connector transmit the vibrations to the bristles,
wherein the distal end of the first shaft is releasably coupled to the proximal end of the second shaft.

2. The bristle head according to claim 1 further comprising a connector (28) surrounding the distal end of the first shaft and the proximal end of the second shaft for releasably coupling the distal end of the first shaft to the proximal end of the second shaft.

3. The bristle head according to claim 2, wherein the connector comprises a core of a first material and a shell surrounding the core of a second material, the first material being more rigid than the second material.

4. The bristle head according to claim 2, wherein the connector engages one of the distal end of the first shaft and the proximal end of the second shaft through a threaded coupling.

5. The bristle head according to claim 2, wherein the connector engages one of the distal end of the first shaft and the proximal end of the second shaft through a bayonet coupling.

6. The bristle head according to claim 2, wherein the connector engages one of the distal end of the first shaft and the proximal end of the second shaft through a friction coupling.

7. A bristle head according to claim 1 wherein the connector includes a sleeve (42) of heat shrink material engaging one of the distal end of the first shaft and the proximal end of the second shaft.

8. The bristle head according to claim 1, wherein the connector comprises adhesive material engaging one of the distal end of the first shaft and the proximal end of the second shaft.

9. The bristle head according to claim 8 wherein the adhesive material is a thermal-releasing adhesive.

10. The bristle head in accordance with claim 1 wherein the first shaft includes a recess (48) in its distal end receiving the proximal end of the second shaft.

11. The bristle head according to claim 1 wherein the distal end of the first shaft includes a recess, the bristle head further comprising a connector (28, 54) having proximal end and a distal end, the proximal end of the connector being inserted into the recess in the distal end of the first shaft, the proximal end of the second shaft being inserted into the distal end of the connector.

12. The bristle head according to claim 1 further comprising a connector (28) having a proximal end and a distal end, the distal end of the first shaft being inserted into the proximal end of the connector, the proximal end of the connector being inserted into the distal end of the second shaft.

13. The bristle head according to claim 1 further comprising a connector (28) having a proximal end and a distal end, the proximal end of the connector being inserted into the distal end of the first shaft, the distal end of the connector being inserted into the proximal end of the second shaft.

14. A method for modifying an electric toothbrush comprising a hand unit, a first shaft having a proximal end and a distal end, first bristles mounted on the proximal end of the first shaft, and means for mounting the first shaft on the hand unit and for responding to a force produced by the hand unit by vibrating the first shaft, the method comprising the steps of:
a. removing the distal end of the first shaft upon which the first bristles are mounted such that the first shaft has a new distal end; and
b. releasably coupling a replacement brush to the new distal end of the first shaft, the replacement brush comprising a second shaft having a distal end and a proximal end and having second bristles mounted on the distal end, the proximal end being releasably coupled to the new distal end of the first shaft.

15. The method in accordance with claim 14 wherein the proximal end of the replacement brush includes a threaded coupling, and wherein step b comprises the substeps of:
b1. connecting the new distal end of the first shaft to a connector, and
b2. connecting the proximal end of the second shaft to the connector.

16. The method according to claim 15, wherein the connector comprises a core of a first material and a shell surrounding the core of a second material, the first material being more rigid than the second material.

17. The method according to claim 15, wherein the connector engages one of the distal end of the first shaft and the proximal end of the second shaft through a threaded coupling.

18. The method according to claim 15, wherein the connector engages one of the distal end of the first shaft and the proximal end of the second shaft through a bayonet coupling.

19. The method according to claim 15, wherein the connector engages one of the distal end of the first shaft and the proximal end of the second shaft through a friction coupling.

20. A method according to claim 15 wherein the connector includes a sleeve (42) of heat shrink material engaging one of the distal end of the first shaft and the proximal end of the second shaft.

21. The method according to claim 15, wherein the connector comprises adhesive material engaging one of the distal end of the first shaft and the proximal end of the second shaft.

22. The method according to claim 21 wherein the adhesive material is a thermal-releasing adhesive.

23. The method in accordance with claim 15 wherein step b comprises the substeps of:
b1. creating a recess (48) in the distal end of the first shaft, and
b2. inserting the proximal end of the second shaft into the recess.

24. The method according to claim 14 wherein step b comprises the substeps of:
b1. forming a recess in the distal end of the first shaft,
b2. inserting a proximal end of a connector into the recess in the distal end of the first shaft; and
b3. inserting the proximal end of the second shaft into a distal end of the connector.

25. The method according to claim 14 wherein step b comprises the substeps of:
b1. inserting a distal end of the first shaft into a proximal end of a connector; and
b2. inserting a distal end of the connector into the proximal end of the second shaft.

26. The method according to claim 14 wherein step b comprises the substeps of:
b1. forming a recess in the distal end of the first shaft,
b2. inserting a proximal end of a connector into the recess in the distal end of the first shaft; and
b3. inserting a distal end of the connector into the proximal end of the second shaft.

27. The method in accordance with claim 14 wherein the proximal end of the second shaft includes a first recess, and wherein step b comprises the substeps of:
b1. forming a second recess in the new distal end of the first shaft, and
b2. inserting a pin into the first and second recesses for releasably coupling the first and second shafts.

28. The method in accordance with claim 15 wherein the pin and the first and second recesses are threaded.
